(19) United States
(12) Patent Application Publication
(10) Pub. No.: US 2009/0313114 A1
(43) Pub. Date: Dec. 17, 2009

(54) Method and System for Location Based Distribution of Content on the Internet

(76) Inventor: Efstratios Arampatzis, Thessaloniki (GR)

Correspondence Address: SKOKOS LAW GROUP, LLC, 1100 JORIE BOULEVARD, SUITE 220, OAK BROOK, IL, 60523, US

(21) Appl. No.: 11/997,790

(22) PCT Filed: Aug. 22, 2006
(86) PCT No.: PCT/GR06/00042

§ 371 Date: Feb. 4, 2008

(30) Foreign Application Priority Data
Aug. 25, 2005 (GR) 20050100445

(51) Int. Cl. G06F 15/173; G06Q 30/00; G06F 15/16

(52) U.S. Cl. 705/14.45; 705/14.53; 705/14.58; 709/217; 709/223

(57) ABSTRACT

The invention allows web servers to take into account the geographic location of users at the time of their connection to the internet, and thus adapt and differentiate the content that is forwarded to the users based on this information. The invention permits this by enabling ISPs to identify the geographic location of their users at the time of their connection, and communicate this information to web servers in order for the web servers to provide geographically targeted content to the ISPs' users. Information on the geographic location of the users is inferred from telecommunication means that is used at the time that users connect to an internet service provider (ISP) or to an internet access network.

### CROSS-REFERENCE TO RELATED APPLICATION

The present application claims priority from Greek application GR 20050100445 filed on Aug. 25, 2005, the content of which is hereby incorporated by reference into this application.

### BRIEF SUMMARY OF THE INVENTION

The invention allows web servers to take into account the geographic location of users at the time of their connection to the internet, and thus adapt and differentiate the content that is forwarded to the users based on this information. The invention permits this by enabling ISPs to identify the geographic location of their users at the time of their connection, and communicate this information to web servers in order for the web servers to provide geographically targeted content to the ISPs' users. Information on the geographic location of the users is inferred from telecommunication means that is used at the time that users connect to an internet service provider (ISP) or to an internet access network.

### BACKGROUND OF THE INVENTION

The internet allows its users to access content that resides on web servers all over the world. This content is organized in web sites and web pages with the use of the HTML language (Hyper Text Markup Language), it is coded based on the IP protocol (Internet Protocol) and is accessed by users via the HTTP protocol (Hyper Text Transfer Protocol). Each user that wishes to access content on the internet via their computer (client computer), initially requests the IP address of the page they wish to see via the HTTP protocol to their Internet Service Provider (ISP). By ISP, what is meant is in general the network or infrastructure through which the users connect to the internet. The ISP in turn makes a request to the relative web server to receive the requested content. The ISP then forwards this content to the user.

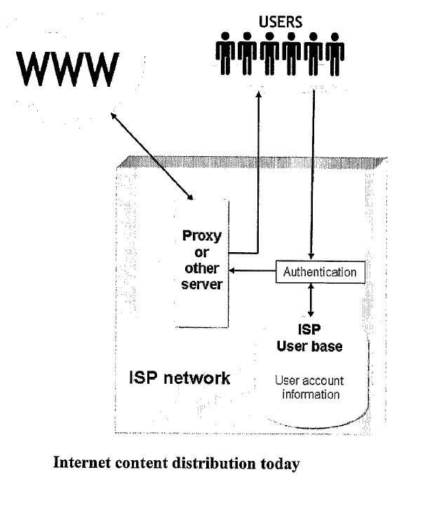

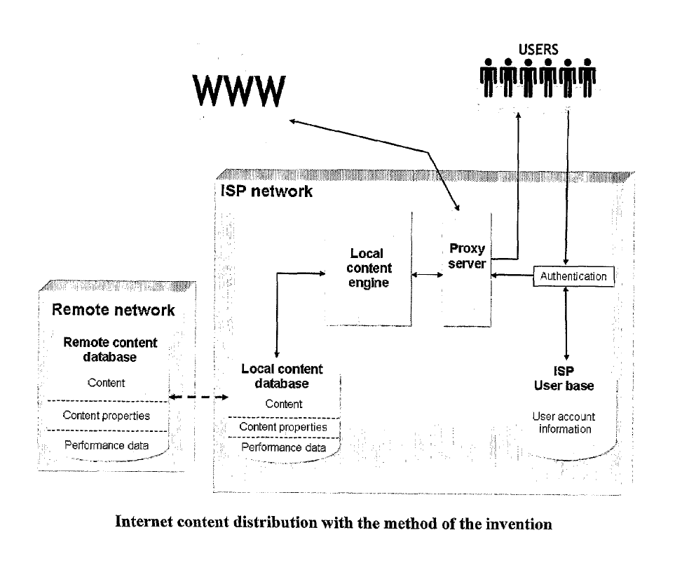

Such process is depicted in FIG. 1 and is presented below:
a. The user connects to the ISP via an authentication mechanism;
b. The user asks to view a web page, annotated as an IP address, by sending an HTTP request to the ISP;
c. The ISP communicates with the web content provider and requests the web page;
d. The web content provider assembles the page and sends it to the ISP; and
e. The ISP sends the page to the user.

Often the content that is delivered to internet users originates from more than one collaborating web servers. These servers can reside outside the ISP's physical network (ie web site servers, advertising servers, etc), or reside inside the ISPs' physical network (ie web proxy servers).

A web proxy server is an ISP service that users access through their internet browsers. A browser connects to the proxy server and requests an internet resource available on a different server (web pages, images, movies etc). The proxy provides the resource either by connecting to the specified server or by serving it from a cache.

Thus the content that is delivered to the user is a combination of content derived from multiple servers which is put together to complete the user's initial request.

The content that is sent to each user that requests the same IP address is not necessarily the same. The content can be differentiated by the web content provider, depending on user interests, or on the recent activity of the user. If, for example, the user has expressed interest for health issues, the web content provider may forward information related to health issues.

User information can be stored in a “user profiles” database. Every user may be assigned a “username” that identifies his profile. Where this profile is editable by the user himself, a password may also be provided. User profiles may contain information such as name, age, sex, address at home and at work, personal interests, consumer characteristics, etc.

Web content providers also try to differentiate content that sent to the users by determining the geographic location (geo-location) of a web site visitor. The geo-location of the visitor can then become a characteristic of his profile. The geo-location determination can be achieved through a variety of methods. The visitor can volunteer their geo-location information via site registration, online purchasing information, etc. The visitor's geo-location can also be inferred through the visitor's IP address—with varying levels of accuracy (depending on the targeting methods used and the degree of specificity (or granularity) required). By using such methods, web content providers can then differentiate the content that send to their visitors based on the determined geo-location of these visitors.

Today's state of the art technologies and methods in relation to content distribution on the internet also enable ISPs to differentiate the content they deliver to their users. A person knowledgeable in the state of the art can embed personalized content in web sites that an ISP's users are viewing, with or without the cooperation of the web sites (the web content providers), based on user profiles that are assembled and maintained either by the ISP or by a third party.

However, neither the web content providers, nor the ISPs, can differentiate content based on the exact geographic location of the user at the time of his connection to the internet. This is because ISPs, who are the only party that may have access to such information, are not today able to access and utilize this information in order to provide differentiated content to their

### SUMMARY OF THE INVENTION

The invention allows web servers to take into account the geographic location of users at the time of their connection to the internet, and thus adapt and differentiate the content that is forwarded to the users based on this information. The invention permits this by enabling ISPs to identify the geographic location of their users at the time of their connection, and communicate this information to web servers in order for the web servers to provide geographically targeted content to the ISPs' users. Information on the geographic location of the users is inferred from telecommunication means that is used at the time that users connect to an internet service provider (ISP) or to an internet access network.

The application of the system does not depend on the geographic location of the ISP, or on the geographic allocation of their IP addresses. The application of the system depends only on the geographic location of the internet user at the time of his connection to the ISP. This location can be inferred by the ISP or by a third party.

The inventive step of the method concerns the retrieval of information that can determine the geographic location of a user at the time of his connection to the ISP, and the utilization of this information order to embed geographically targeted content to the content that this user is viewing on the internet.

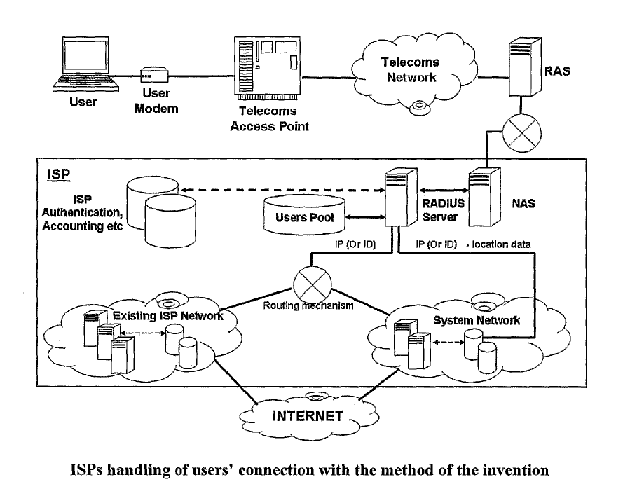

The process of the present invention is illustrated in FIG. 2 and presented below:
a. The user connects to the ISP and in turn with the system via an authentication mechanism located on the ISP's infrastructure;
b. The user asks to view a web page, annotated as an IP address, by sending an HTTP request to the ISP;
c. The system receives the request, along with information that determines the geographic location of the user, communicates with the web content provider and requests the page;
d. The web content provider sends the page to the system through the ISP;
e. The system checks for an indication that would allow the inclusion of local content in the page;
f. In the case where the inclusion of local content is not allowed, the system forwards the page to the user in its initial format (as it received it from the web content provider);
g. In the case where the inclusion of local content is allowed the system incorporates local content into the content that was obtained from the web content provider, utilizing information that determines the geographic location of the user; and
h. The ISP sends the locally modified page to the user.

### DETAILED DESCRIPTION OF THE INVENTION

The present invention enables the differentiation and delivery of content to each user based on the geographic location of the user at the time of his connection to the ISP. When a user connects to the internet by means of, but not limited to, a DSL or dial-up modem, data travels from the user through the telecommunication infrastructure that the ISP uses to one of many available RAS (Remote Access Server) routers that are responsible for the communication with an available NAS (Network Access Server) at the ISP.

This data may contain the username/password of the user, the Caller ID number for PSTN and ISDN connections, DSLAM identification strings for xDSL, leased lines, or other information that can geographically determine the user's access point or the user's location. The Network Access Server receives this data and passes them to a RADIUS server (Remote Authentication Dial-In User Service), or on any available authentication server, that in turn checks if the received data/information permits the user to have access to the ISP's infrastructure, using authentication schemes like PAP, CHAP or EAP. If accepted, the server then authorizes access to the ISP system and assigns an IP address, L2TP parameters, etc. to the user. The server uses a routing mechanism to transfer the user to an appropriate server within the ISP network, so that the user gains access to the internet. This can be done either by IPTABLES on a Linux based router or some other hardware device depending on the ISP setup (i.e. Cisco router).

The RADIUS server (or any other authentication server) may also communicate with other elements in the ISP's infrastructure, being capable of reading/writing to text files, LDAP servers, databases, etc, and may transmit all available data/information on the user to any of these elements. To deploy the method of the invention, the RADIUS server communicates with a local content engine and connects the user's assigned IP (or any other unique identification code) with the user's geographic location as following:
IP→Dial number prefix or other information that can geographically identify a user eg.: 10.3.8.48→23105 or
   10.3.8.48→VM812200200280 (where V stands for the state (Victoria), M for the city (Melbourne), and the rest of the information safely and adequately identifies a Remote Access Server and a Network Access Server in Australia).

The geographic location is specified either based on information that can be extracted from elements found outside the ISP infrastructure (such as the user's phone or other elements that the user connects with through his area's telecommunications infrastructure), or by information that can be extracted from elements found inside the ISP infrastructure (such as network elements used by the user to connect to the ISP).

The local content engine receives this information from the RADIUS server and transcribes it into a zip code identifier that defines the geographical location of the user. This transcription is performed by matching the dial number prefix or other information (eg. RAS location) with zip codes that are found in zip code tables for the country. The transcription is enabled by the utilization of appropriate algorithms. The result is the matching of each user to one zip code (or a range of zip codes in the case that an exact match is not possible).

In case that the geographic location of the user cannot be safely identified with the above process, the local content engine or the RADIUS server may connect to the ISP's user information base, and extract the user's zip code, phone prefix, or any other information.

As a supplementary step that can also be applied independently, the user can voluntarily submit location information to the system through a conceived interface such as, but not limited to, a web form, so that the user gains access to the system's service.

As part of standard ISP procedures, the RADIUS server is also notified if and when a user session starts and stops. When a user's session of the system stops, the RADIUS server may be required to delete from the system the IP/postcode or any other information entered on startup.

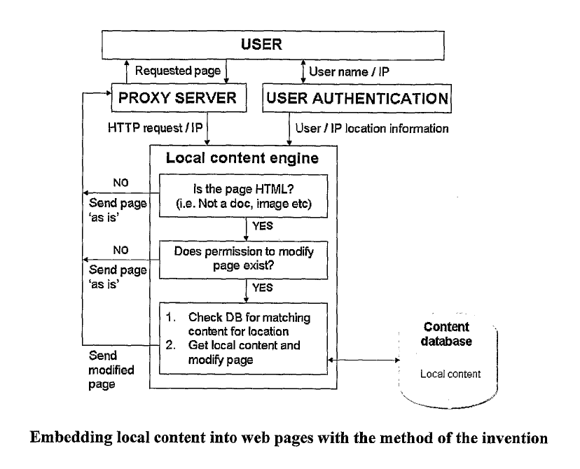

The above process is illustrated in FIG. 3.

The local content engine may filter the content that the user is receiving from the internet, and, at the same time, may embed geographically targeted content into the content that the user is accessing. The engine receives HTTP requests from the user, combines his IP address with his geographical location (zip code), and embeds content that is related to his geographical location into the web pages of the web sites that the user views on his screen. This process is depicted in diagram 4 and described below:
a) The ISP's proxy server receives the HTTP request of the user, communicates with the related web site and requests the corresponding web page;
b) The web site sends the HTML code of the page to the proxy server, and prepares for the forwarding of other page content that is included, such as graphics etc.;
c) The proxy server forwards initially the HTML code and then all the received content to the local content engine;
d) The engine initially checks if the received content is HTML code or not;
e) If the content is not HTML code, then the engine returns the content to the proxy server exactly as it received it, and the proxy server sends the page to the user in its initial format (as it received it from the web site);
f) If the content is HTML code, the engine checks the HTML code for the presence of indications that would allow the inclusion of local geographically targeted content and specify the terms for its inclusion (i.e. size of image, etc.);
g) In the case where the inclusion of local geographically targeted content is not allowed, then the engine returns the content to the proxy server exactly as it received it, and the proxy server sends the page to the user in its initial format (as it received it from the web site);
h) In the case where the inclusion of local geographically targeted content is allowed the engine communicates with local servers and provides them with information determining the geographic location of the user (the zip code—or the range of zip codes that have been assigner to the user). The engine requests content based on this information;
i) The local servers provide content that has been marked as available or relevant with this geographic location;
j) The engine incorporates the geographically targeted content into the initial content that has been received from the web site through the proxy server and sends the page to the proxy server; and
k) The proxy server sends the locally modified page to the user.

The invention allows for the application of a new business practice concerning advertising on the internet. Today's business practices assume that advertising material can be embedded into the web content at source (the web site). The invention allows the inclusion of advertisements in the web content at the point of delivery (the ISP).

In one embodiment of the method, advertising material can be embedded into the web content that the users are viewing at the ISP level, based on their locations. Today advertisements are incorporated into the content of web sites in the form of text, images (banners), or rich media objects. Because visitors to a web site can come from all over the world and have different profiles, web sites try to categorize their visitors in a way that will allow them to target advertisements only at specific categories of visitors. For example, the search engines (a place used to seek information with the help of key words) offer advertisers the possibility to advertise only to customers that use certain key words. Thus, the companies advertising using this method believe that internet users that will see their advertisements have an interest for their service or product.

However, websites cannot efficiently categorize their visitors based on their geographic location. And even when they can do this, they cannot achieve the needed granularity to attract advertisers at zip code level; even when visitors voluntarily provide information to a web site about their geographic location, it is not possible even for large web sites to isolate a substantial number of visitors from a specific geographic location (a neighborhood in a city) and efficiently target advertisements based on the exact geographic location of their visitors.

Instead of having the web content providers (the web sites) embed advertisements in their content, the invention enables ISPs to identify internet users in a geographic location and deliver targeted advertisements to them. By implementing the method of the invention, the ISPs, or a third party that is collaborating with the ISPs, may embed geographically targeted advertisements into the web content they deliver to their users.

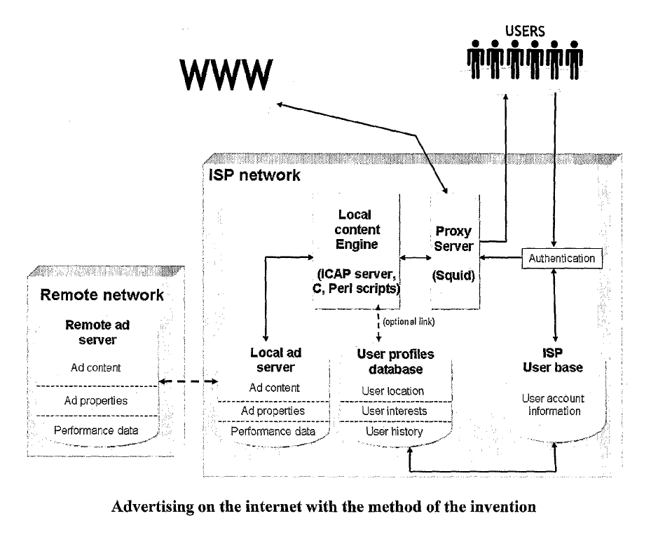

In one indicative embodiment, as illustrated in FIG. 5, the local content engine has been deployed in an ICAP server that communicates with software programs written in C and Perl, and is connected to a Squid proxy server. The system also includes a user profiles server (customer profiles server), which communicates user related information with the engine. This information is recorded in the form of selection data (user clickstream) and may used to infer user preferences in internet browsing. The user profiles are continuously updated dynamically depending on the users activities.

An ad server communicates with each user's internet browser via the local content engine and the proxy server and forwards relative advertisements. Specifically, the ad server consists of three (3) internal mechanisms. The ad content mechanism that provides the advertisement material categorized in groups (i.e. restaurants, dry cleaners etc) and locality at zip code level. The ad properties mechanism that controls when and which ad should be available and ready for distribution (i.e. the company Tero has a registered banner but only for use between the dates Jan. 1, 2006 and Jan. 3, 2006). Finally, the ad server records the impression or click through of an ad in the performance data. This can be used to audit the system, charge advertisers the cost of delivered ads, and distribute the revenue to all involved stakeholders (i.e. to the owner of the ad server, the ISP, web sites etc).

A user profiles database can be also part of the system to register user locations, interests, clickstream history, and other user characteristics, thus enabling further targeting of delivered ads.

I hereby claim:

1. Method for distribution of web content from a web content provider's hardware to a user's hardware via an internet service provider network, whereby i) the user's hardware includes hardware means to access a telecommunications network, which telecommunications network includes a telecommunications access point, ii) the internet service provider network includes a network access server, and iii) the internet service provider network is linked to a content engine, which content engine communicates the web content to the user; the method comprising the following steps:
a. establishing a connection between the user's hardware and the network access server via the telecommunications access point;
b. the user submits a request to view a web content;
c. transferring the user's request from the hardware means to access a telecommunications network to the network access server, through the telecommunications network;
d. the network access server transfers the user's request to the web content provider;
e. the content engine receives the web content that corresponds to the user's request;
f. identifying the geographical location of the user;
g. depending on the identification of the geographical location of the user, the content engine embeds additional content to the web content that corresponds to the user's request and delivers the web content with the embedded additional content to the user's hardware;
the method being characterized in that
h. the geographical location of the user is determined from information identifying the geographical location of the telecommunications network;
i. the said information is retrieved from the connection that is established between the user's hardware and the internet service provider network access server through the telecommunications access point; and
j. the said information is communicated to the content engine by the internet service provider network.

2. The method according to claim 1, further characterized in that the network access server communicates to the content engine the information identifying the geographical location of the telecommunications network, and the content engine determines the geographical location of the user on the basis of the information identifying the geographical location of the telecommunications network.

3. The method according to claim 1, further characterized in that the content engine includes a first database including the additional content.

4. The method according to claim 1, further characterized in that the content engine includes a first database where the additional content is classified in more than one group.

5. The method according to claim 1, further characterized in that the content engine includes a first mechanism that stores the terms that control the inclusion of the additional content to the web content.

6. The method according to claim 1, further characterized in that the content engine includes a second mechanism that stores information concerning the addition of the additional content to the web content.

7. A method according to claim 1, further characterized in that the web content provider includes an indication in the web content that geographically targeted content can be embedded thereto.

8. A method according to claim 1, further characterized in that the information to identify the geographic location of the user is deleted after the user's connection to the internet service provider network is terminated.

9. System for distribution of web content from a web content provider's hardware to a user's hardware via an internet service provider network, whereby the user's hardware includes hardware means to access a telecommunications network, which telecommunications network includes a telecommunications access point, and the internet service provider network includes a network access server, and whereby the system includes
a. means to link the system to the internet service provider network;
b. means to identify the geographical location of the user;
c. means to add additional content to the web content that corresponds to the user's request;
d. means to deliver the web content with the embedded additional content to the user's hardware;
the system being characterized in that it further comprises
e. means to extract information to identify the geographical location of the telecommunications network from the network access server; and
f. means to identify the geographical location of the user on the basis of the information identifying the geographical location of the telecommunication network.

10. A system according to claim 9, further characterized in that the content engine includes a database including the additional content.

11. A system according to claim 9, further characterized in that the content engine includes a database where the additional content is classified in more than one group.

12. The system according to claim 9, further characterized in that the content engine includes a first mechanism that stores the terms that control the inclusion of the additional content to the web content.

13. The method according to claim 9, further characterized in that the content engine includes a second mechanism that stores information concerning the addition of the additional content to the web content.

14. A system according to claim 9, further characterized in that the content engine includes means to check for an indication that allows the incorporation of geographically targeted content in the web content that has been forwarded to it from the web content provider.

15. A system according to claim 9, further characterized in that it includes a third mechanism enabling the recording of feedback concerning the embedded additional content.

16. A system according to claim 9, further characterized in that it includes a mechanism enabling the monitoring and recording of user activity, so that user profiles are kept and updated depending on their latest internet browsing activity.
